(19) United States
(12) Patent Application Publication
(10) Pub. No.: US 2005/0250357 A1
(43) Pub. Date: Nov. 10, 2005

(54) Chassis ground wire for vehicles

(76) Inventors: Hung-Yao Chen, Puyen Hsiang (TW); Shih-Yu Hu, Yangmei Chen (TW)

Correspondence Address: DELLETT AND WALTERS, P. O. BOX 2786, PORTLAND, OR, 97208-2786, US

(21) Appl. No.: 10/842,903

(22) Filed: May 10, 2004

(51) Int. Cl. H01R 4/66

(52) U.S. Cl. 439/92

(57) ABSTRACT

A chassis ground wire for vehicles includes an outside jacket, a battery negative connection wire, a body connection wire, a voltage exciter and a clamping device. The outside jacket has two opposite ends and a passage defined completely through the outside jacket. The connection wires connect respectively to the opposite ends of the outside jacket and each of them includes a conductor and an insulated coating coated around the conductor. Each conductor has an inside end that extends into and is held in the passage. The voltage exciter is mounted in the passage of the outside jacket and includes a coil with two ends respectively connected to the inside ends of the conductors. The clamping device including screws or deformed inward protrusions is mounted in the outside jacket to hold the inside ends of the conductors in the passage.

### BACKGROUND OF THE INVENTION

1. Field of the Invention

The present invention relates to a ground wire, and more particularly to a chassis ground wire for a robust connection of chassis ground of vehicles, especially cars.

2. Description of Related Art

The term chassis ground refers to electrical circuits inside a car are all connected to one common ground, which, for convenience, is the metal body of the car. Grounding or ground wires provide direct connections from the car's battery negative to the car's metal body for chassis ground inside the car. A conventional chassis ground wire in accordance with the prior art comprises a battery negative connection wire, a body connection wire and a voltage exciter. Each of the connection wires has two opposite ends and comprises a conductor and an insulated coating. The insulated coating isolates the conductor.

The voltage exciter is coupled between adjacent ends of the connection wires and connects to conductors of the connection wires. To prevent the voltage exciter from separating, insulating tape is used to wrap around the voltage exciter and neighboring areas of the connection wires to combine the voltage exciter with the connection wires together.

However, the connection effects of the insulating tape will become weakened after a long-term use of the chassis ground wire. The adhesive affects of the insulating tape are gradually lost and the voltage exciter and the ends of the connection wires may become disconnected from each other. The voltage exciter will separate easily from the ends of the connection wires if the insulating tape cannot hold the connection and the conventional chassis ground wire will not be able to work when the voltage exciter is separated.

To overcome the shortcomings, the present invention provides a chassis ground wire with a voltage exciter that provides a reliable connection to mitigate or obviate the aforementioned problems.

### SUMMARY OF THE INVENTION

The main objective of the invention is to provide a chassis ground wire with a voltage exciter for vehicles such as cars, and the chassis ground wire provides a reliable and robust connection from the car's battery negative to the car's metal body.

A chassis ground wire for vehicles in accordance with the present invention includes an outside jacket, a battery negative connection wire, a body connection wire, a voltage exciter and a clamping device. The outside jacket has two opposite ends and a passage with an interior surface defined completely through the outside jacket. The battery negative connection wire and the body connection wires connect respectively to the opposite ends of the outside jacket, and each of the connection wires includes a conductor and an insulated coating formed around the conductor. Each conductor has an inside end that extends into and is held in the passage. The voltage exciter is mounted in the passage of the outside jacket and has a coil with two ends respectively connected to the inside ends of the conductors. The clamping device including screws or deformed inward protrusions is mounted in the outside jacket to hold the inside ends of the conductors in the passage.

Other objectives, advantages and novel features of the invention will become more apparent from the following detailed description when taken in conjunction with the accompanying drawings.

### BRIEF DESCRIPTION OF THE DRAWINGS

FIG. 1 is a top plan view of a first embodiment of a chassis ground wire in accordance with the present invention;

FIG. 2 is an enlarged side sectional plan view of the chassis ground wire in FIG. 1; and

FIG. 3 is an enlarged side sectional plan view of a second embodiment of the chassis ground wire in accordance with the present invention.

### DETAILED DESCRIPTION OF PREFERRED EMBODIMF ENT

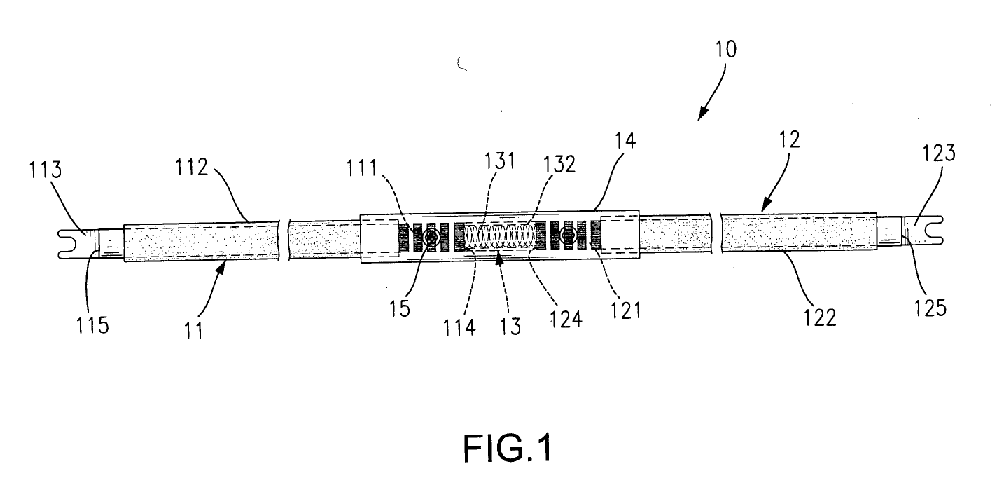

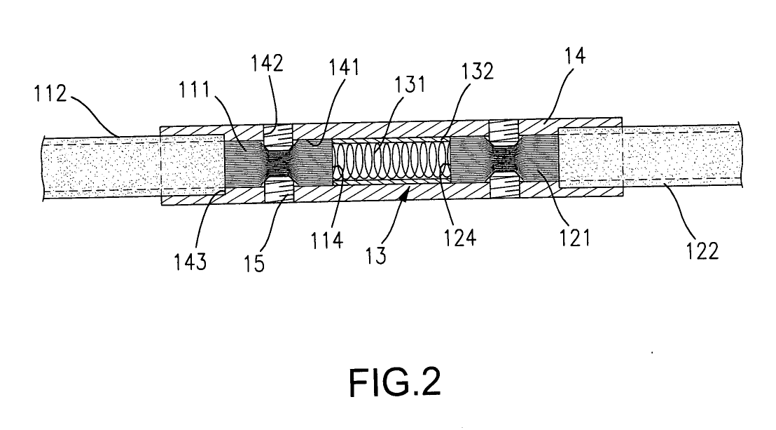

With reference to FIGS. 1 and 2, a grounding wire (10) in accordance with the present invention comprises a battery negative connection wire (11), a body connection wire (12), a voltage exciter (13), an outside jacket (14) and a clamping device including four screws (15).

The battery negative connection wire (11) comprises a conductor (111), an insulated coating (112) and a terminal (113). The conductor (111) has an inside end (114) and an outside end (115). The insulating coating (112) coats the conductor (111). The terminal (113) is attached to the outside end (115) of the conductor (111).

The body connection wire (12) comprises a conductor (121), an insulated coating (122) and a terminal (123). The conductor (121) has an inside end (124) and an outside end (125). The insulating coating (122) coats the conductor (121). The terminal (123) is attached to the outside end (125) of the conductor (121).

The voltage exciter (13) is coupled to and between the inside ends (114,124) of the conductors (111, 121) and comprises a coil (131) and a coil jacket (132). The coil (131) has two ends that connect respectively to the inside ends (114, 124) of the conductors (111, 121). The coil jacket (132) is a hollow tubing, can be made of composite or ceramics materials and holds the coil (131) inside.

The outside jacket (14) is a hollow metal tubing and holds the voltage exciter (13) and the inside ends (114, 124) of the conductors (111, 121) inside. The outside jacket (14) has two opposite ends, a passage (141) with an interior surface and four threaded holes (142). The passage (141) is axially defined completely through the outside jacket (14), which defines two openings at the ends of the outside jacket (14). The interior surface has two annular shoulders (143) that are defined respectively adjacent to the ends of the outside jacket (14). The threaded holes (142) are transversely completely defined through the outside jacket (14) at positions between the annular shoulders (143).

The inside ends (114, 124) of the conductors (111, 121) extend respectively into the passage (141) through the openings to contact the coil (131) and are held in the passage (141) with the insulated coatings (112, 122) abut respectively the annular shoulders (143) in the passage (141).

The screws (15) screw respectively into and are held in the threaded holes (142) and clamp respectively the inside ends (114, 124) of the conductors (111,121) to connect the wires (11, 12) with the voltage exciter (13). Therefore, the outside jacket (14) will hold firmly the wires (11, 12) with the voltage exciter (13) together.

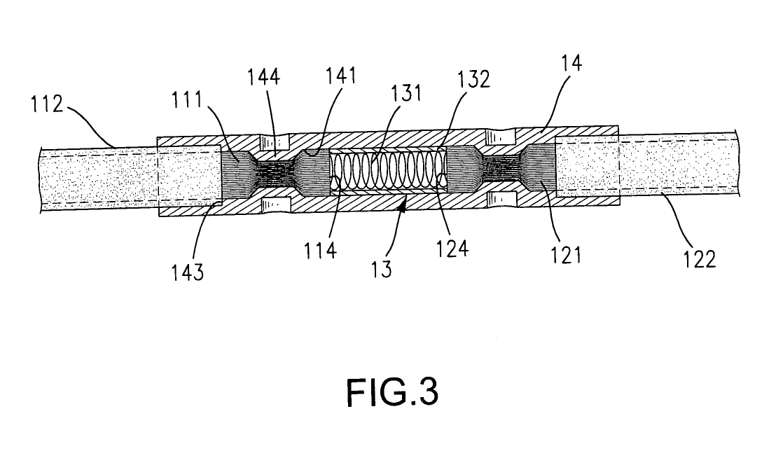

With reference to FIG. 3, a second embodiment of the present invention is a modification of the clamping device. The clamping device is modified with multiple deformed inward protrusions (144). The deformed inward protrusions (144) are pressed at positions between the annular shoulders (143) and clamp the inside ends (114, 124) of the conductors (111, 121).

Consequently, the conductors (111, 121) of the wires (11, 12) and the voltage exciter (13) will be firmly connected to each other by the outside jacket (14) and the clamping device including the screws (15) or the deformed inward protrusions (144). The robust connection will keep the wires (11, 12) and the voltage exciter (13) from being easily separated from each other after a long-term use. The present invention provides a reliable connection for the chassis ground for the vehicles.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A chassis ground wire for vehicles and the chassis ground wire comprising:
an outside jacket having two opposite ends and a passage with an interior surface defined completely through the outside jacket;
a battery negative connection wire and a body connection wire connected respectively to the opposite ends of the outside jacket and each of the battery negative and the body connection wires comprising
a conductor having an outside end and an inside end extended into and held in the passage; and
an insulated coating formed around the conductor;
a voltage exciter mounted in the passage of the outside jacket and having two ends respectively connected to the inside ends of the conductors; and
a clamping device mounted in the outside jacket to hold the inside ends of the conductors in the passage.

2. The chassis ground wire as claimed in claim 1, wherein
the outside jacket further has two annular shoulders formed respectively on the interior surface at the ends of the outside jacket; and
the insulated coatings of the battery negative and the body connection wires abut respectively the annular shoulders in the outside jacket.

3. The chassis ground wire as claimed in claim 2, wherein
the outside jacket further comprises multiple threaded holes defined transversely completely through the outside jacket between the annular shoulders; and
the clamping device comprises multiple screws mounted respectively in the threaded holes to clamp the inside ends of the conductors.

4. The chassis ground wire as claimed in claim 3, wherein the voltage exciter comprises a coil mounted between the inside ends of the conductors and having two ends coupled respectively to the inside ends of the conductors, and a coil protector mounted around the coil between the inside ends of the conductors.

5. The chassis ground wire as claimed in claim 4, further comprising two terminals attached respectively to the outside ends of the conductors.

6. The chassis ground wire as claimed in claim 2, wherein the clamping device comprises multiple deformed inward protrusions formed between the annular shoulders to clamp respectively the inside ends of the conductors.

7. The chassis ground wire as claimed in claim 6, wherein the voltage exciter comprises a coil mounted between the inside ends of the conductors and having two ends coupled respectively to the inside ends of the conductors, and a coil protector mounted around the coil between the inside ends of the conductors.

8. The chassis ground wire as claimed in claim 7, further comprising two terminals attached respectively to the outside ends of the conductors.
